(19) United States
(12) Patent Application Publication
(10) Pub. No.: US 2012/0080376 A1
(43) Pub. Date: Apr. 5, 2012

(54) USE OF DESALINATION BRINE FOR ION EXCHANGE REGENERATION

(75) Inventors: Andy Komor, Irvine, CA (US); Keisuke Ikehata, Fountain Valley, CA (US)

(73) Assignee: Pacific Advanced Civil engineering, Inc.

(21) Appl. No.: 12/897,641

(22) Filed: Oct. 4, 2010

(51) Int. Cl. B01J 49/00; C02F 1/44; C02F 1/42

(52) U.S. Cl. 210/638; 210/677; 210/269

(57) ABSTRACT

One embodiment provides a method of regenerating an ion exchange medium, the method comprising: (i) providing an ion exchange medium comprising at least one first multivalent cation; (ii) providing an effluent comprising at least one monovalent cation and optionally at least one second multivalent cation, wherein the effluent comprises a desalination brine, and wherein, if the second multivalent cation is present, the monovalent cation and the second multivalent cation in the effluent are present at a ratio of at least about 200; and (iii) contacting the ion exchange medium with the effluent to promote an interaction between the second cation and the ion exchange medium, whereby the ion exchange medium is regenerated.

### FIELD OF THE INVENTION

The present invention is related to a process and system of regenerating an ion exchange medium via recycling the waste brine stream obtained from desalination.

All of the references cited in this Specification are incorporated herein by reference in their entirety.

### BACKGROUND

Due to the global water shortage, an increasing number of previously unexplored, highly saline, and hard source waters are being treated by various desalination processes, including ion exchange and membrane processes. Although the beneficial use of cation exchange as a pre-treatment of membrane desalination has been suggested, the costs associated with this pre-treatment method may become inhibitory for its large scale application.

Present day desalination methods use a plurality of processes to remove salts of different ions from wastewaters from municipal, industrial, and agricultural sources, as well as from seawater and brackish groundwater. Typically, a series of membrane filtration processes are employed, including microfiltration (MF), ultrafiltration (UF), nanofiltration (NF), reverse osmosis (RO), electrodialysis (ED), and electrodialysis reversal (EDR). These membrane processes, except MF, produce a purified water stream and a concentrate stream (also known as brine, or desalination brine), which needs further treatment or a disposal method. Although RO typically produces the most concentrated brine stream, ED, EDR, and NF also produce a waste stream that contains salts at concentrations substantially higher than those of source water.

Because of the high salt content therein, treatment or disposal of membrane brine becomes a challenge in those areas where access to a proper disposal facility, such as evaporation ponds, ocean outfalls and deep injection wells, is limited or unavailable. Depending on the initial salt content of the source water, the volume of membrane brine may range from 5 to 50% of the volume of source water treated. A large volume of water, as well as the salts in it, is currently wasted.

It is known that groups of dissolved ions in source water can cause scaling due to mineral deposit at the membrane surface during membrane desalination; the scaling can significantly reduce the purified water recovery. The mineral deposit comprises combinations of particular anions (i.e., sulfate, carbonate, and bicarbonate) and multivalent cations (e.g., Ca²⁺, Mg²⁺, Sr²⁺, Ba²⁺, Fe²⁺, and Fe³⁺). These multivalent cations are commonly referred to as hardness ions. Currently, specially and are be used to prevent scaling and mineral deposition during the membrane filtration. However, the effectiveness of such antiscalants is still limited where particularly hard water is being treated. Due to the global water shortage, an increasing number of water producers and water users are seeking new water resources, such as seawater, brackish groundwater, brackish agricultural water, and treated wastewater effluent. These water resources typically have a high salt content, as well as high hardness. As a result, they have not been explored.

Traditionally, 10 to 15% (w/v) solution of NaCl (3.9 to 5.9% (w/v) as Na⁺) has been employed in regenerating a spent cation exchange medium used for hardness removal in water treatment. This results in significant operational costs due to the purchase of chemicals, as well as due to the loss in product water used to produce the salt solution, especially where very hard source water is treated because more frequent regeneration is needed.

In order to increase the purified water yield of hard water membrane desalination, a need exists to remove either (i) all the anions associated with hardness, including sulfate, carbonate, and bicarbonate, or (ii) all the hardness cations prior to the membrane process. Anion removal is often impractical, and various processes may be employed to remove hardness cations and soften hard water. Common water softening processes include lime-soda ash, membrane, and strong and weak acid cation exchange processes. However, all of these softening processes often need additional expenses in the form of chemicals or energy, and they produce another liquid waste stream in the form of sludge, spent regenerant, or brine that needs additional treatment. In addition, the liquid waste stream represents a substantial reduction in overall product water recovery.

Thus, a need exists to improve the desalination process such that the hardness of the source water can be removed without incurring substantial cost in regenerating the ion exchange medium and without relying on the produced purified water as part of the regeneration process.

### SUMMARY

One object of the present invention is to utilize membrane desalination brine, which would otherwise be wasted, in regenerating ion exchange medium, thus effectively eliminating one of the liquid waste streams. A membrane concentrate often contains a high level of Na⁺, along with various anions originally present in the source water, but a low level of hardness ions. In one embodiment described herein, the membrane concentrate can be used to regenerate a spent cation exchange medium, which is used in a pre-treatment step of membrane desalination. This can significantly reduce the operational cost and increase the yield of product water. Also, since less concentrated Na⁺ is used in regeneration, the amount of rinse water needed can be reduced significantly. In one embodiment, no addition of chemicals is needed to achieve water softening and desalination.

One embodiment provides a method of regenerating an ion exchange medium, the method comprising: (i) providing an ion exchange medium comprising at least one first multivalent cation; (ii) providing an effluent comprising at least one monovalent cation and optionally at least one second multivalent cation, wherein the effluent comprises a desalination brine, and wherein, if the second multivalent cation is present, the monovalent cation and the second multivalent cation in the effluent are present at a ratio of at least about 200; and (iii) contacting the ion exchange medium with the effluent to promote an interaction between the second cation and the ion exchange medium, whereby the ion exchange medium is regenerated.

Another embodiment provides a method of regenerating an ion exchange medium, the method comprising: (i) contacting an aqueous medium comprising at least one first multivalent cation with an ion exchange medium to produce an effluent comprising a monovalent cation and optionally at least one second multivalent cation; (ii) obtaining a concentrate stream by increasing a concentration of the monovalent cation in the effluent such that, if the second multivalent cation is present, the monovalent cation and the second multivalent cation are present in the effluent at a ratio of at least about 200; and (iii) contacting the concentrate stream with the ion exchange medium to promote an interaction between the concentrate stream and the ion exchange medium, whereby the ion exchange medium is regenerated. In one embodiment, no multivalent cations are present.

One embodiment provides a desalination plant, wherein a desalination brine is used to regenerate an ion exchange medium that has undergone an ion exchange process, wherein a ratio of a monovalent cation to a multivalent cation present in the desalination brine is at least about 200.

Another embodiment provides a method of regenerating an ion exchange medium in a desalination plant, the method comprising: contacting an ion exchange medium comprising a multivalent cation as exchange ion with a desalination brine comprising a first plurality of monovalent cations and a second plurality of multivalent cations under a condition that promotes regeneration of the ion exchange medium, wherein the first plurality and the second plurality are present in the desalination brine at a ratio of at least about 200.

Another embodiment provides a desalination system, the system comprising: (i) an ion exchange unit, comprising an ion exchange medium; and (ii) a desalination unit, from which a desalination brine is produced; wherein the desalination brine is used to regenerate the ion exchange medium and wherein a first plurality of monovalent cations and a second plurality of multivalent cations are present in the desalination brine at a ratio of at least about 200.

### BRIEF DESCRIPTION OF THE DRAWINGS

FIGS. 1A-1B shows the water flow scheme for (A) the cation exchange followed by membrane desalination in an existing operation, and (B) another embodiment wherein a portion of the water is used as rinse water. The thickness of arrows represents the relative water flow volume.

FIGS. 2A-2B show the water flow schemes for: (A) the conventional cation exchange medium regeneration using 10 to 15% (w/v) NaCl solution as a regenerant, and (B) the regeneration process as described in one embodiment herein, using membrane brine containing a high level of Na⁺.

FIGS. 3A-3B show the water flow scheme for the rinse of ion exchange medium at the end of regeneration using a portion of the product water (B) and separately obtained rise water (B).

FIG. 4 shows results of regeneration of spent strong acid cation exchange medium with a reverse osmosis reject brine, containing 1.4% (=14 g/L) Na⁺, which is equivalent of 3.6% NaCl and 160 mg/L (as CaCO₃) of total hardness at pH=9.1.

FIG. 5 shows a comparison of hardness breakthrough. Ion Exchange resin was regenerated with different regenerants, including 16% NaCl, 5% NaCl, and a reverse osmosis brine reject with 1.4% Na⁺ (equivalent of 3.6% NaCl) and 160 mg/L (as CaCO₃) of total hardness. The source water contained 2.2 g/L Na⁺ and 1.2 g/L (as CaCO₃) total hardness.

### DETAILED DESCRIPTION

The presently described methods and systems utilize a desalination brine, such as the desalination brine from a membrane desalination process, that would otherwise be wasted in regenerating an ion exchange medium, thereby substantially eliminating one of the liquid waste streams. A membrane desalination process can be nanofiltration, reverse osmosis, electrodialysis, electrodialysis reversal, or combinations thereof.

The detailed description herein illustrates specific embodiments of the invention, but is not meant to limit the scope of the invention. Unless otherwise specified, the words “a” or “an” as used herein mean “one or more.” The terms “substantially” and “about” used throughout this Specification are used to describe and account for small fluctuations. For example, they can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%.

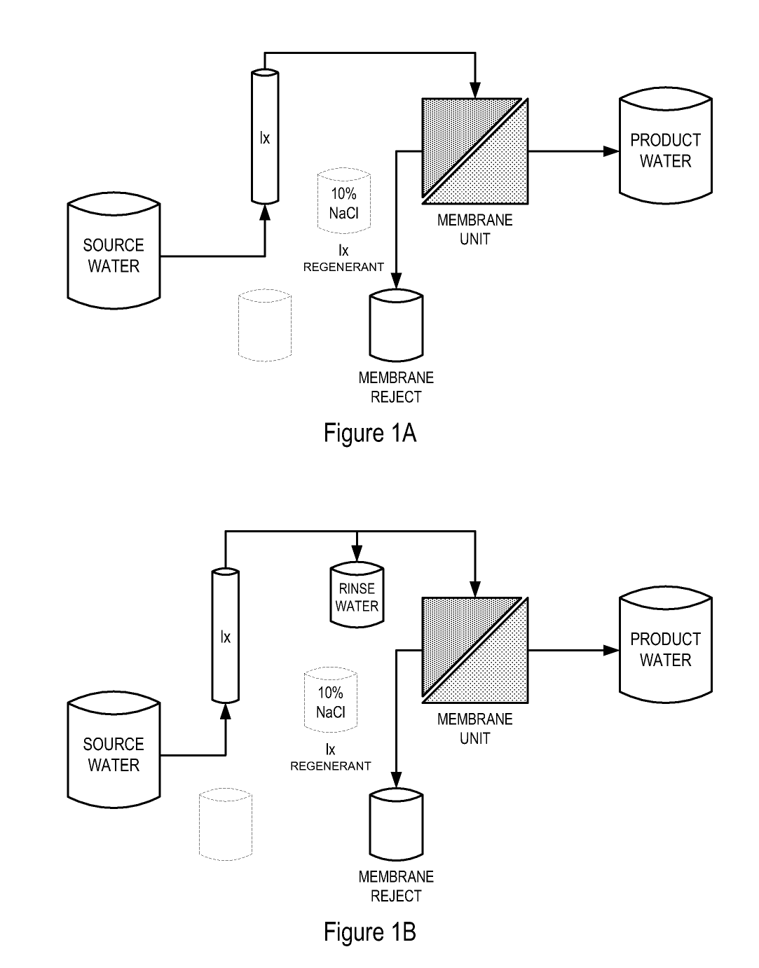

In general, a desalination process removes ions such as cations and anions from the brackish to saline water streams by undergoing at least first an ion exchange process, in which hardness ions, such as multivalent, or sometimes some monovalent, cations in the source water streams are replaced (or “exchanged”) with monovalent ions contained in an ion exchange medium. A monovalent ion refers to an ion having a valence of one. A multivalent ion refers to an ion having a valence of greater than one, such as two (“divalent”), three (“trivalent”), four, or more. An ion exchange medium can comprise a natural or a synthetic medium, or both. An embodiment of a general desalination system is depicted in FIGS. 1A-1B. As a result of the ion exchange process, the ion exchange medium, which initially contains a monovalent cation as exchange ion (such as a sodium ion), would then contain multivalent cations, and the source water that has undergone an ion exchange process would contain mostly monovalent cations. This process can be described by Equation (1), which is described further below.

The resultant water subsequently undergoes a desalination process, such as a membrane desalination process, that concentrates remaining soluble ions, such as monovalent ions (e.g., Na⁺), in one stream and produces purified water in another stream. The concentrate obtained from a desalination process, such as a membrane desalination process (or “membrane concentrate”), often can contain a high level of monovalent cations, such as alkaline metal ions, such as Na⁺ ion, and various anions originally present in the source water; the concentration often contains a low level of hardness ions. The anions can be any anions that are present in common source water. For example the anion can be SO₄²⁻, CO₃²⁻, and HCO₃⁻, halogen ions (e.g., F⁻, Cl⁻, Br⁻, and I⁻), oxyanions (e.g., SO₃²⁻, HPO₄²⁻, NO₂ ⁻, NO₃⁻, ClO₄⁻, AsO₃³⁻, AsO₄³⁻, SeO₃²⁻, and SeO₄²⁻), or combinations thereof. In one embodiment, the concentration of the oxyanions is much lower than that of Cl⁻, SO₄²⁻, CO₃²⁻, and HCO₃⁻.

In one embodiment described herein, the membrane concentrate can be used to regenerate a spent cation exchange medium, which is used in a pre-treatment step of membrane desalination. The cation exchange medium, or “ion exchange medium,” can be part of a desalination system. See FIGS. 1A-1B. The membrane concentrate can be obtained from increasing the concentration of the desalination brine during a pre-treatment and/or pre-concentration step. Alternatively, in one embodiment, the membrane concentrate can refer to desalination brine that has not undergone a concentration process; in other words, the desalination brine can be used directly in the regeneration process without being first concentrated.

### Ion Exchange

Source water, such as brackish or saline water, can contain various types of ions, including cations and anions. The cations can be multivalent cations. These multivalent cations are often referred to as “hardness ions” or “hardness cations.” For example, they can be a divalent ion such as alkali earth ions, including ions of beryllium, magnesium, calcium, strontium, or other ions of same or higher valences, such as divalent iron, trivalent iron, or they can be combinations thereof. In one embodiment, the cation is at least one of Ca²⁺, Mg²⁺, Fe²⁺, Fe³⁺, Sr²⁺, and Ba²⁺. Occasionally, hardness ions can also include a cation with a valence of one, such as alkali metal ions, such as lithium, sodium, potassium.

Source water can undergo a pre-treatment prior to the ion exchange step. For example, the source water can undergo a biological treatment or a gas treatment to remove unwanted species from the water.

In one embodiment, a brackish to saline aqueous medium such as one comprising brackish groundwater, agricultural drain water, treated sewage effluent, treated agricultural and industrial wastewater, seawater, or combinations thereof, is first impounded in a reservoir or tank. The aqueous medium can be referred to as “source water.” The source water can undergo suitable pre-treatment prior to the desalination process. Pre-treatment can include solid removal and chemical oxidation. The source water can contain a plurality of various cations and/or anions, as described above. For example, the source water can comprise a plurality of first cations, such as hardness cations (as opposed to the second cation in the ion exchange medium). The multivalent hardness cations are often present in a greater concentration than monovalent cations.

In one embodiment, the source water can then be subjected to cation exchange in the sodium cycle where hardness metal ions (i.e., multivalent cations, such as alkali earth cations, including Ca²⁺, Mg²⁺, Ba²⁺, and Sr²⁺, and Fe²⁺, Fe³⁺) in the source water are replaced with a monovalent cation, such as an alkali metal ion, including Na⁺, which is originally associated with the ion exchange medium. See Equation (1). In one embodiment, some of the multivalent cations might still be present. The ion exchange process can be described in Equation (1) below.

2 R̅S̅O̅₃̅⁻̅N̅a̅⁺̅+Ca²⁺ [symbol] (̅R̅S̅O̅₃̅⁻̅)̅2̅C̅a̅²̅⁺̅+2Na⁺ (1)

Generally, the ion exchange takes place in a packed column, where water to be treated is introduced at one end and the effluent is collected at the other end.

The ion exchange medium can comprise a resin. The resin need not be of any particular type of shape. In one embodiment, the resin preferably does not have a bead form. In another embodiment, the resin preferably does not have a core-shell like structure. The resin can be made of any suitable polymer. For example, the resin can comprise a crosslinked polymer. In one embodiment, the resin comprises a sulfonated styrene crosslinked with divinylbenzene, sodium form.

The effluent from the cation exchange process contains substantially no multivalent cations but a large amount of Na⁺ and other monovalent cations, such as K⁺, though in a smaller amount. Minute amounts of multivalent might also be present. In one embodiment, some of the effluent (“membrane effluent”), instead of clean purified water, can be used to rinse the ion exchange medium before the effluent is further concentrated. See e.g., FIGS. 1A-1B. In one embodiment, these hardness ions will be captured by the ion exchange medium until the capacity of the medium is reached. At that point, the medium is deemed “spent” or “exhausted” and needs to be regenerated. In one embodiment, the term “spent” need not refer to only a medium reaching its maximum ion exchange capacity; rather, the term can refer to an ion exchange medium that has been used at least once for ion exchange.

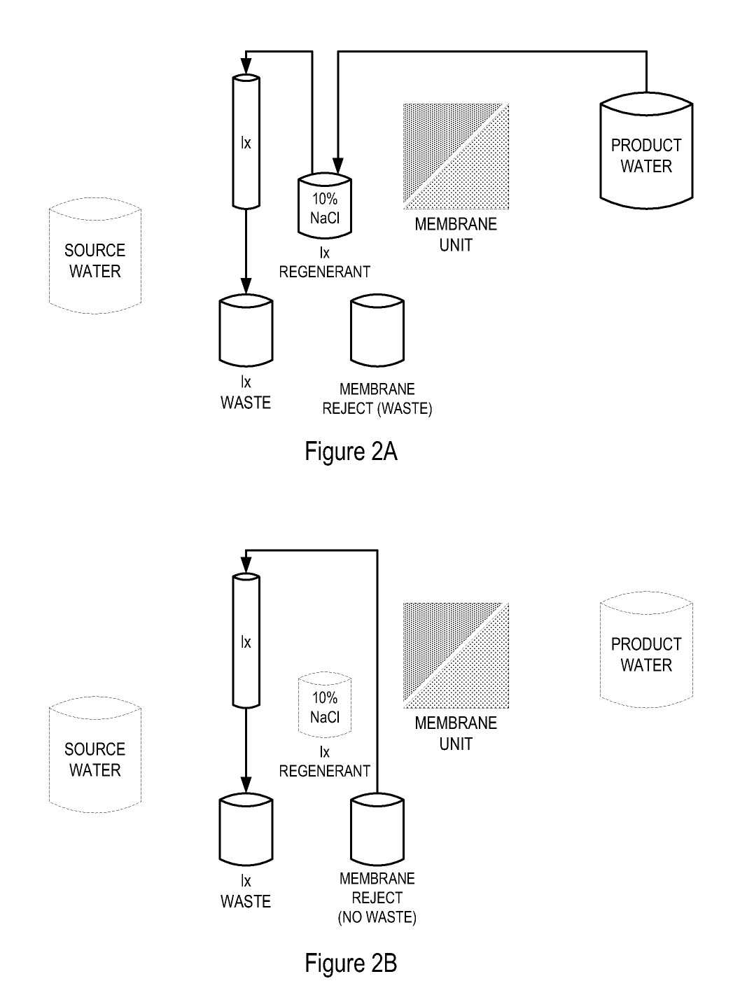

Conventionally, as illustrated in FIG. 2A, the regeneration of a spent ion exchange medium is performed by flushing the spent ion exchange column with a solution of 10 to 15% (w/v) NaCl, or “regenerant.” Not to be bound by a particular theory, but because the ion exchange reactions are reversible (see Equation (1)), an increase in the concentration of Na⁺ would drive the equation leftwards—i.e., forcing the multivalent cations out of the ion exchange medium, and the medium returns to the monovalent sodium form. A regenerant is typically prepared by dissolving an appropriate amount of NaCl in a given volume of clean water that contains little hardness in it (FIG. 2A). In general, clean water is obtained from the water purified by the desalination process. The spent regenerant is a liquid waste, which may undergo additional treatment or be disposed of.

The effluent from the cation exchange process can be subjected to a membrane desalination process, wherein the remaining dissolved ions, mostly monovalent cations, such as Na⁺, K⁺, and anions, such as Cl⁻, SO₄²⁻, and HCO₃⁻, are concentrated by a process such as a membrane process in one stream (i.e., brine), and purified water is produced as another stream. The brine stream is usually considered as a liquid waste stream (FIG. 2A).

### Regeneration

In one embodiment, the presently described method utilizes the brine, which otherwise could have been wasted, to regenerate a spent ion exchange medium. In this embodiment, the brine need not be obtained from the same desalination plant or system as the ion exchange medium. For example, the brine can be obtained from the desalination plant at a different location from the place where the regeneration is carried out. Alternatively, the brine can be obtained from the same location (e.g., plant) where the regeneration is carried out.

In one embodiment, the ion exchange medium is a spent ion exchange medium. Specifically, the spent ion exchange medium can contain a concentration of at least one cation. The cations in a spent ion exchange medium in some embodiments are multivalent ions. The state of the exchange medium can be represented by that shown in the right side of Equation (1). The concentration of the multivalent cation at the exchange site can be of any value, depending upon when such an exchange medium is deemed “spent,” as described previously, and thus to be regenerated.

The spent ion exchange medium can be used to contact an effluent. The effluent can comprise a desalination brine obtained from the desalination process. As described above, in one embodiment, the brine can be obtained from a different location than the regeneration and/or ion exchange medium. The effluent can comprise at least one monovalent cation and optionally at least one multivalent cation. The multivalent cation can be any of the aforementioned multivalent cations. It is desirable to minimize the presence of the multivalent cation in the brine. Not to be bound by any particular theory, but this is because the multivalent cations would compete with the monovalent cations during the regeneration process, thereby reducing the efficiency of the process. For example, in one embodiment, when the concentration of the hardness (multivalent) ions exceeds 2 g/L, the regeneration process can become impractical; thus, it is desirable to keep the concentration of the hardness ion low, such as less than 1 g/L, such as less than 0.5 g/L, such as less than 0.1 g/L, such as less than 0.05 g/L, such as less than 0.01 g/L. For example, the molar ratio of the monovalent cation to the multivalent cation present in the effluent can be at least about 100, such as at least about 200, such as at least about 400, such as at least about 800. In one embodiment, the effluent is substantially free of multivalent cations, such as completely free of multivalent cations; in that case, the ratio would approach infinity.

The presently described system and methods allow for regeneration of an ion exchange medium with a brine containing a much lower concentration of monovalent ions, compared to existing ion exchange regenerants. At the same time, the presently described system and methods preferably utilize a brine that contains a threshold concentration of the monovalent cation in order for them to be effective. For example, an existing ion exchange regenerant typically contains 40 to 60 g/L of sodium ion (equivalent to 10 to 15% (w/v) as NaCl). By contrast, in one embodiment, a membrane brine as presently described can contain less than or equal to about 40 g/L of sodium ions, such as less than or equal to about 30 g/L, such as less than or equal to about 20 g/L of sodium ion. At the same time, it is desirable for the presently described brine to have a concentration of sodium ion of at least about 5 g/L, such as at least about 10 g/L, such as at least about 15 g/L.

The actual sodium ion concentration in membrane brine may vary depending on factors such as source water salinity, salt rejection rate, and water recovery rate. For example, assuming the source water Na⁺ concentration of 1 g/L, 90% water recovery, and a salt rejection rate of 99.9%, the brine sodium ion concentration would be 10 g/L.

The effluent and the spent exchange medium can then be brought in contact with each other under a condition that promotes an interaction between the monovalent cation and the ion exchange medium including the multivalent cation. The regeneration can take place under conventional operation conditions, such as a pH of usually between 6 and 10 and a temperature of usually between slightly below and slightly above ambient temperature—in some embodiments, the conditions are within the ranges specified by the ion exchange medium manufacturer. The interaction can be, for example, a chemical reaction, such as a reversible chemical reaction, such as that described in Equation (1). The effluent can first be concentrated to increase the concentration of the monovalent cation before being brought into contact with the ion exchange medium. The monovalent cations from the brine, such as sodium ions, can drive the equation towards the left, thus regenerating the spent ion exchange medium—i.e., returning it to the monovalent ion form.

As illustrated in FIGS. 2A and 2B, one embodiment of the presently described method utilizes a desalination brine, such as that from a membrane desalination process, to regenerate the ion exchange medium. As a result, one of the liquid waste streams is substantially eliminated. This can significantly increase the yield of product water. Also, because less concentrated Na⁺ is used in regeneration, the rinse water requirement can be reduced significantly.

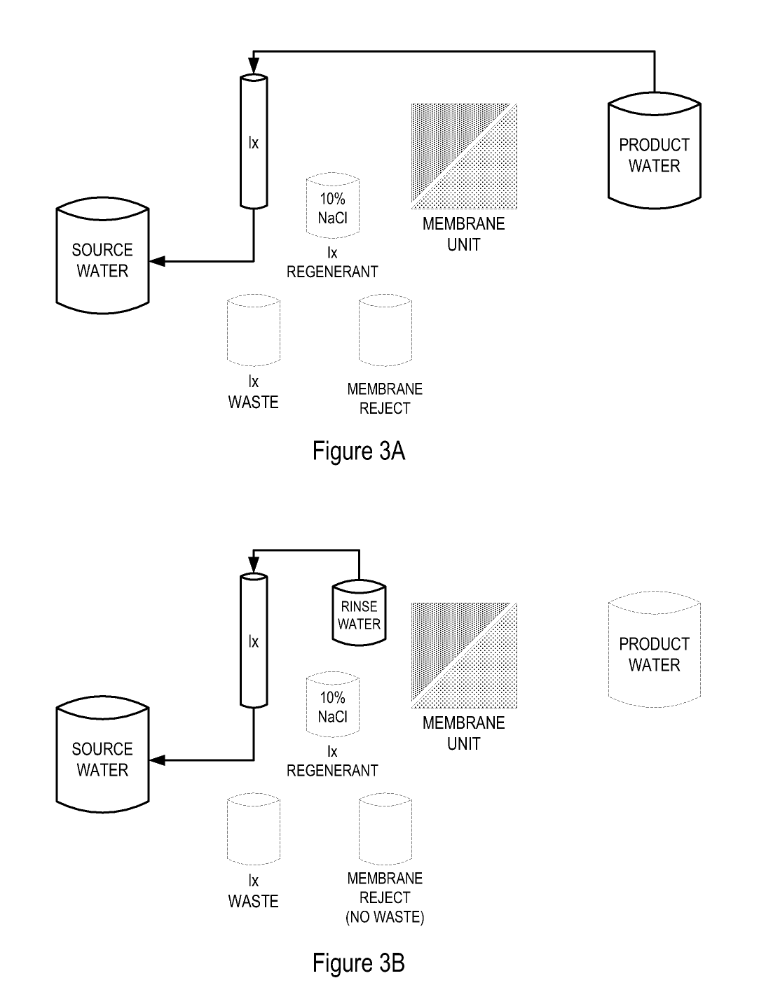

At the end of regeneration, the ion exchange medium can be rinsed with clean water that is low in sodium and hardness to flush out residual hardness and excess sodium in the ion exchange column. Typically, clean water obtained by membrane desalination is used for the rinse (FIG. 3A). Alternatively, an effluent from ion exchange (i.e., membrane influent; FIG. 1B) may be used to rinse the regenerated medium (FIG. 3B). This approach can save energy and improve the overall process efficiency.

The regeneration can take place in the same plant or system as the desalination process, such as a membrane desalination process. The ion exchange process and the desalination process can be as described above. The desalination brine from the desalination process can be fed as an effluent into the regeneration process to regenerate the spent ion exchange medium, as described above. Alternatively, the brine can be first concentrated to increase the concentration of the monovalent contained therein to produce a concentrated effluent, or concentrate stream, which can then be used to regenerate the spent ion exchange medium. The concentrating process can be a membrane process, a thermal process, a freeze-thaw process, a natural evaporation process, an electrochemical process, or combinations thereof. The regeneration can be as described above.

In one embodiment, the present system utilizes otherwise wasted membrane brine having high sodium content to regenerate the spent cation exchange medium (FIG. 2B). One advantage of the presently described methods and systems is that a sodium content of the regenerant used in the present system can be lower than that needed in a conventional regeneration system (i.e., 10 to 15% NaCl solution). Alternatively, the brine stream may be concentrated by means of thermal concentration, such as evaporation, or another membrane process to achieve a desired Na⁺ concentration that may be more suitable for the medium regeneration. If needed, the concentrated stream can be further concentrated to further increase the concentration of the monovalent cations.

The presently described methods can be used to retrofit or integrate into a pre-existing desalination plant. For example, the desalination brine from the desalination process can be taken to contact a spent ion exchange medium (containing a multivalent cation as exchange ion) such that the regeneration process as described above can take place. In addition, the water recovery of an existing membrane desalination system, which does not have ion exchange pretreatment, may be increased by adding ion exchange softening prior to membrane desalination with brine recycle.

One embodiment provides a desalination plant, wherein the regeneration of the ion exchange medium as described above takes place. Namely, the desalination brine produced from within the plant or from a different plant is used to regenerate a spent ion exchange medium. In one embodiment, at least 90%, such as at least about 95%, such as at least about 99%, such as 100% of the desalination brine can be recycled. For example, because most of the desalination brine is recycled, the output of the desalination plant can be substantially free of desalination brine. Further, in one embodiment of the presently described plant, the purified water produced therein need not be used to prepare salt solution during the regeneration of the ion exchange medium.

An alternative embodiment of the presently described system and process can be a desalination system comprising a plurality of units that respectively perform the aforementioned functions. For example, the system can comprise an ion exchange unit, in which the ion exchange process takes place. The ion exchange unit can comprise an ion exchange medium. The system can comprise a desalination unit, in which the desalination takes place. In one embodiment, the desalination produces both the desalination brine on one hand and purified water on the other. The brine, which can be the effluent as described above, can then be used to regenerate the ion exchange medium, as described above.

### NON-LIMITING WORKING EXAMPLES

### Example 1

In one embodiment, a commercial cation exchange resin was successfully regenerated with a membrane brine containing 14 to 20 g/L sodium and 160 to 200 mg/L total hardness (as CaCO₃). The molar ratio between sodium (23 g/mol) and hardness (100 g/mol) was about 400.

### Example 2

In another embodiment, a brackish source water was used in the beginning with 1.5 to 4.0 g/L sodium, 1.0 to 1.7 g/L hardness (as CaCO₃), and 7 to 13 g/L total dissolved solids (TDS). As already shown above, the brine contained 14 to 20 g/L sodium and 160 to 200 mg/L total hardness (as CaCO₃). The sodium and TDS content of a source water may be in the range of 0.5 to 5.0 g/L and 2 to 20 g/L, depending on the membrane process efficiency (i.e., water recovery rate and salt rejection rate) and other source water quality parameters, such as silica content.

### Example 3

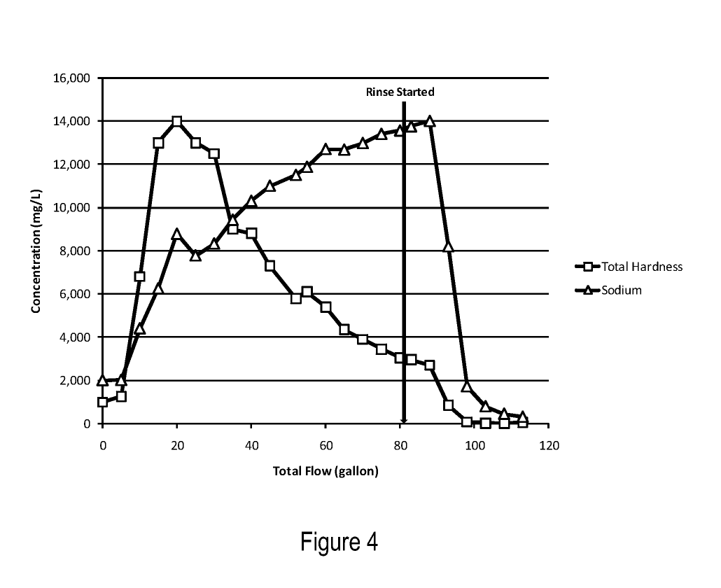

FIG. 4 provides results from ion exchange medium regeneration trials using a membrane reject brine. In this example, the majority of total hardness captured by the medium during softening was eluted after 80 min (80 gallon of regenerant at a flow rate of 1 gallon per min). The medium can be ready for the next cycle of hardness removal (i.e., softening) process, as shown in FIG. 1. The regeneration of spent strong acid cation exchange medium took place with a reverse osmosis reject brine containing 1.4% (=14 g/L) Na⁺, which is equivalent to 3.6% NaCl, and 160 mg/L (as CaCO₃) of total hardness at pH=9.1. The ion exchange resin used was ResinTech CG10-UPS strong acid cation exchanger (sulfonated styrene crosslinked with divinylbenzene, sodium form); flow rate=1.0 gallon per min; empty bed resin volume=10 gallons, temperature=17° C.

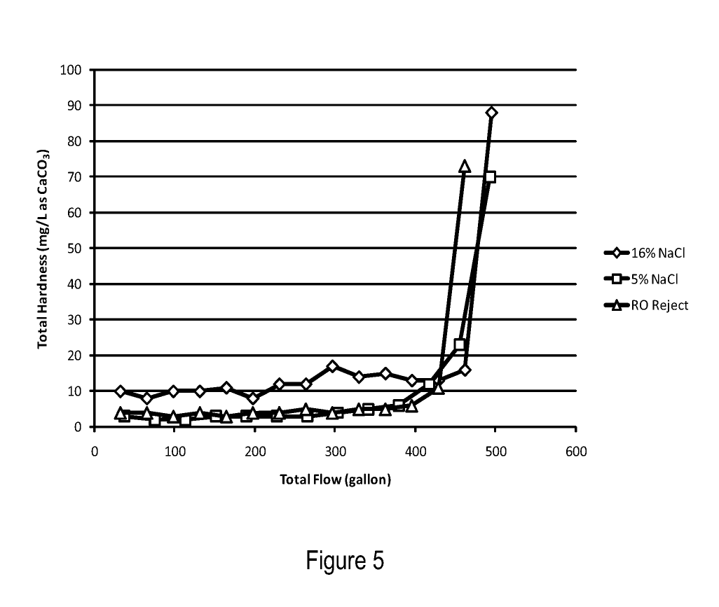

FIG. 5 shows the comparison of hardness breakthrough curves. The ion exchange medium was regenerated using three different regenerants, namely 16% NaCl, 5% NaCl, and a reverse osmosis brine reject with 1.4% Na⁺ (equivalent of 3.6% NaCl) and 160 mg/L (as CaCO₃) of total hardness. The source water contained 2.2 g/L Na⁺ and 1.2 g/L (as CaCO₃) total hardness. Similar to above, the ion exchange resin used was ResinTech CG10-UPS strong acid cation exchanger (sulfonated styrene crosslinked with divinylbenzene, sodium form); flow rate=1.1 gallon per min; empty bed resin volume=10 gallons; pH=9.1, temperature=17° C.

It can be seen from FIG. 5 that the ion exchange medium regenerated with the RO brine performed as well as the media regenerated with conventional NaCl solution prepared in purified water.

What is claimed:

1. A method of regenerating an ion exchange medium, comprising:
(i) providing an ion exchange medium comprising at least one first multivalent cation;
(ii) providing an effluent comprising at least one monovalent cation and optionally at least one second multivalent cation, wherein the effluent comprises a desalination brine, and wherein, if the second multivalent cation is present, the monovalent cation and the second multivalent cation in the effluent are present at a ratio of at least about 200; and
(iii) contacting the ion exchange medium with the effluent to promote an interaction between the second cation and the ion exchange medium, whereby the ion exchange medium is regenerated.

2. The method of claim 1, wherein step (ii) further comprises pre-treating, pre-concentrating, or both, the effluent.

3. The method of claim 1, wherein the first multivalent cation is at least one of a divalent cation and trivalent cation.

4. The method of claim 1, wherein the ion exchange medium is used in an ion exchange process of a desalination process.

5. The method of claim 1, wherein the first multivalent cation is at least one of Ca²⁺, Mg²⁺, Fe²⁺, Fe³⁺, Sr²⁺, and Ba²⁺.

6. The method of claim 1, wherein the second multivalent cation is at least one of Ca²⁺, Mg²⁺, Fe²⁺, Fe³⁺, Sr²⁺, and Ba²⁺.

7. The method of claim 1, wherein the monovalent cation is at least one of K⁺ and Na⁺.

8. The method of claim 1, wherein the monovalent cation is present at a concentration of between about 5 g/L to about 30 g/L.

9. The method of claim 1, wherein the monovalent cation is present at a concentration of between about 10 g/L to about 20 g/L.

10. The method of claim 1, wherein the ratio in step (ii) is at least about 400.

11. The method of claim 1, wherein the effluent is substantially free of a multivalent cation.

12. The method of claim 1, wherein the ion exchange medium comprises a resin that does not have a bead shape.

13. The method of claim 1, wherein the interaction is a reversible chemical reaction.

14. The method of claim 1, wherein step (ii) further comprises increasing a concentration of the monovalent cation before step (iii).

15. The method of claim 1, wherein step (ii) further comprises increasing a concentration of the monovalent cation by a membrane process, a thermal process, a freeze-thaw process, a natural evaporation process, an electrochemical process, or combinations thereof.

16. The method of claim 1, wherein the ion exchange medium comprises a synthetic ion exchange medium, a natural ion exchange medium, or a combination thereof.

17. The method of claim 1, wherein the ion exchange medium comprises Na⁺ as an exchange ion.

18. The method of claim 1, wherein the desalination brine is obtained from a membrane desalination process.

19. The method of claim 1, wherein the desalination brine is obtained from a process involving nanofiltration, reverse osmosis, electrodialysis, electrodialysis reversal, or combinations thereof.

20. The method of claim 1, wherein the effluent comprises a waste stream obtained from a desalination process.

21. A method of regenerating an ion exchange medium, comprising:
(i) contacting an aqueous medium comprising at least one first multivalent cation with an ion exchange medium to produce an effluent comprising a monovalent cation and optionally at least one second multivalent cation;
(ii) obtaining a concentrate stream by increasing a concentration of the monovalent cation in the effluent such that, if the second multivalent cation is present, the monovalent cation and the second multivalent cation are present in the effluent at a ratio of at least about 200; and
(iii) contacting the concentrate stream with the ion exchange medium to promote an interaction between the concentrate stream and the ion exchange medium, whereby the ion exchange medium is regenerated.

22. The method of claim 21, wherein the first multivalent cation is at least one of a divalent cation and a trivalent cation.

23. The method of claim 21, wherein a portion of the effluent is not concentrated, and the portion is used to rinse the regenerated ion exchange medium after step (iii).

24. The method of claim 21, wherein the ion exchange medium comprises a resin that is not in a bead form.

25. The method of claim 21, wherein the ion exchange medium comprises Na⁺ as an exchange ion.

26. The method of claim 21, wherein step (ii) is carried out with a membrane process.

27. The method of claim 21, wherein the regenerated ion exchange medium after step (iii) is used in step (i).

28. The method of claim 21, wherein the monovalent cation is present at a concentration of between about 10 g/L to about 20 g/L.

29. The method of claim 21, wherein step (iii) further comprises increasing a concentration of the concentrate stream by a membrane process, a thermal process, a freeze-thaw process, a natural evaporation process, an electrochemical process, or combinations thereof.

30. The method of claim 21, wherein step (ii) is carried out via nanofiltration, reverse osmosis, electrodialysis, electrodialysis reversal, or combinations thereof.

31. A desalination plant, wherein a desalination brine is used to regenerate an ion exchange medium that has undergone an ion exchange process, wherein a ratio of a monovalent cation to a multivalent cation present in the desalination brine is at least about 200.

32. The plant of claim 31, wherein at least 90% of the desalination brine is recycled.

33. The plant of claim 31, wherein an output of the plant is substantially free of desalination brine.

34. The plant of claim 31, wherein regeneration of the ion exchange medium does not involve purified water produced by the desalination plant.

35. A method of regenerating an ion exchange medium in a desalination plant, comprising: contacting an ion exchange medium comprising a multivalent cation as exchange ion with a desalination brine comprising a first plurality of monovalent cations and a second plurality of multivalent cations under a condition that promotes regeneration of the ion exchange medium, wherein the first plurality and second plurality are present in the desalination brine at a ratio of at least about 200.

36. The method of claim 35, further comprising rinsing the regenerated ion exchange medium with an effluent from the ion exchange medium.

37. The method of claim 35, wherein the regenerated ion exchange medium is not rinsed with desalinated water produced in the plant.

38. The method of claim 35, wherein the monovalent cation is Na⁺.

39. A desalination system, comprising:
(i) an ion exchange unit, comprising an ion exchange medium; and
(ii) a desalination unit, from which a desalination brine is produced;
wherein the desalination brine is used to regenerate the ion exchange medium and wherein a first plurality of monovalent cations and a second plurality of multivalent cations are present in the desalination brine at a ratio of at least about 200.

40. The desalination system of claim 39, wherein the desalination unit uses a membrane desalination process.
